(19) United States
(12) Patent Application Publication
(10) Pub. No.: US 2015/0300738 A1
(43) Pub. Date: Oct. 22, 2015

(54) APPARATUS AND METHOD FOR TUBE DRYER

(71) Applicant: Astec, Inc., Chattanooga, TN (US)

(72) Inventors: J. DON BROCK, Chattanooga, TN (US); Malcolm L. SWANSON, Chickamauga, GA (US); Gary CATLETT, Hixson, TN (US)

(73) Assignee: Astec, Inc., Chattanooga, TN (US)

(21) Appl. No.: 14/734,887

(22) Filed: Jun. 9, 2015

Related U.S. Application Data
(63) Continuation-in-part of application No. 13/134,016, filed on May 26, 2011.
(60) Provisional application No. 61/396,336, filed on May 26, 2010.
(60) Provisional application No. 61/397,373, filed on Jun. 10, 2010.

(51) Int. Cl. F26B 11/02

(52) U.S. Cl. CPC F26B 11/028

(57) ABSTRACT

A dryer having an inlet end, a discharge end, an exterior shell, a discharge end manifold and an inlet end manifold. The preferred dryer also comprises a primary tube adapted to convey heat transfer oil to and from the dryer, a discharge end secondary tube which is in fluid communication with the primary tube and the discharge end manifold, and an inlet end secondary tube which is in fluid communication with the inlet end manifold. The preferred dryer further comprises a plurality of tertiary tubes which are in fluid communication with the discharge end manifold and the inlet end manifold, a heat source that is adapted to heat the heat transfer oil, and a sweep gas assembly. The preferred method comprises providing such a dryer, introducing heat transfer oil into the dryer, introducing wood materials into the dryer and drying the wood materials.

### CROSS-REFERENCES TO RELATED APPLICATIONS/PATENTS

This application is a continuation-in-part application that relates back to and claims the benefit of priority from U.S. patent application Ser. No. 13/134,016 entitled “Apparatus and Method for Tube Dryer” and dated May 16, 2011, which relates back to and claims the benefit of priority from U.S. Provisional Application for Patent No. 61/396,336 entitled “Apparatus and Method for a Dryer” and dated May 26, 2010 and U.S. Provisional Application for Patent No. 61/397,373 entitled “Dryer Assembly” and dated Jun. 10, 2010.

### FIELD OF THE INVENTION

The present invention relates generally to dryers, and particularly to rotary dryers adapted to dry wood products.

### BACKGROUND AND DESCRIPTION OF THE PRIOR ART

It is known to use dryers to dry a variety of materials. Conventional dryers, however, suffer from a number of disadvantages. For example, conventional dryers use burner assemblies to produce heat for drying materials. The burners used in conventional dryers are not adapted to dry combustible materials. The burners used in conventional dryers also produce undesirable emissions including volatile organic compounds. In addition, burners used in conventional dryers produce relatively high temperatures which contribute to the production of undesirable emissions. Further, burners used in conventional dryers increase the risk of a fire or an explosion in the dryer. Still further, the oxygen-rich atmosphere inside a conventional dryer increases the risk of a fire or an explosion in the dryer.

It would be desirable, therefore, if an apparatus and method could be provided that would dry materials without the use of a burner assembly. It would also be desirable if such an apparatus and method could be provided that would dry materials that are combustible. It would be further desirable if such an apparatus and method could be provided that would minimize the production of undesirable emissions when drying materials. It would be still further desirable if such an apparatus and method could be provided that would reduce the temperature inside the dryer when drying materials. It would also be desirable if such an apparatus and method could be provided that would reduce the risk of a fire and an explosion in the dryer when drying materials. It would be further desirable if such an apparatus and method could be provided that would reduce the amount of oxygen inside the dryer when drying materials.

### ADVANTAGES OF THE PREFERRED EMBODIMENTS OF THE INVENTION

Accordingly, it is an advantage of the preferred embodiments of the invention disclosed herein to provide an apparatus and method that dries materials without the use of a burner assembly. It is also an advantage of the preferred embodiments of the invention disclosed herein to provide an apparatus and method that dries materials that are combustible. It is another advantage of the preferred embodiments of the invention disclosed herein to provide an apparatus and method that minimizes the production of undesirable emissions when drying materials. It is yet another advantage of the preferred embodiments of the invention disclosed herein to provide an apparatus and method that reduces the temperature inside the dryer when drying materials. It is still another advantage of the preferred embodiments of the invention disclosed herein to provide an apparatus and method that reduces the risk of a fire and an explosion in the dryer when drying materials. It is a further advantage of the preferred embodiments of the invention disclosed herein to provide an apparatus and method that reduces the amount of oxygen inside the dryer when drying materials. It is a still further advantage of the preferred embodiments of the invention to provide an apparatus and method that is adapted to torrefy wood materials.

Additional advantages of the preferred embodiments of the invention will become apparent from an examination of the drawings and the ensuing description.

### EXPLANATION OF TECHNICAL TERMS

As used herein, the term “heat transfer oil” includes any and all fluids adapted to transfer heat, including but not limited to heat transfer fluids, hot oils, thermal fluids and thermal oils.

As used herein, the term “wood materials” includes any and all plant material or vegetation that can be converted to useful fuel or source of energy, including but not limited to biomass material and hard lignous substances composed primarily of xylem.

### SUMMARY OF THE INVENTION

The invention comprises a dryer having an inlet end, a discharge end, an exterior shell, a discharge end manifold disposed near the discharge end of the dryer and an inlet end manifold disposed near the inlet end of the dryer. The preferred dryer also comprises a primary tube adapted to convey heat transfer oil to and from the dryer, a discharge end secondary tube which is in fluid communication with the primary tube and the discharge end manifold and adapted to convey heat transfer oil, and an inlet end secondary tube which is in fluid communication with the inlet end manifold and adapted to convey heat transfer oil. The preferred dryer further comprises a plurality of tertiary tubes which are in fluid communication with the discharge end manifold and the inlet end manifold and adapted to convey heat transfer oil and a heat source that is adapted to heat the heat transfer oil.

The invention also comprises a method for drying wood materials. The preferred method comprises providing a dryer having an inlet end, a discharge end, an exterior shell, a discharge end manifold disposed near the discharge end of the dryer and an inlet end manifold disposed near the inlet end of the dryer. The preferred dryer also comprises a primary tube adapted to convey heat transfer oil to and from the dryer, a discharge end secondary tube which is in fluid communication with the primary tube and the discharge end manifold and adapted to convey heat transfer oil, and an inlet end secondary tube which is in fluid communication with the inlet end manifold and adapted to convey heat transfer oil. The preferred dryer further comprises a plurality of tertiary tubes which are in fluid communication with the discharge end manifold and the inlet end manifold and adapted to convey heat transfer oil and a heat source that is adapted to heat the heat transfer oil. The preferred method also comprises introducing heat transfer oil into the dryer, introducing wood materials into the dryer and drying the wood materials.

### BRIEF DESCRIPTION OF THE DRAWINGS

The presently preferred embodiments of the invention are illustrated in the accompanying drawings, in which like reference numerals represent like parts throughout, and in which:

FIG. 1 is a perspective view from the discharge end of the preferred embodiment of the dryer in accordance with the present invention.

FIG. 2 is a perspective view from the inlet end of the preferred dryer illustrated in FIG. 1.

FIG. 3 is a front view of the preferred dryer illustrated in FIGS. 1-2.

FIG. 4 is a top view of the preferred dryer illustrated in FIGS. 1-3.

FIG. 5 is a right side view of the preferred dryer illustrated in FIGS. 1-4.

FIG. 6 is a left side view of the preferred dryer illustrated in FIGS. 1-5.

FIG. 7 is a partial sectional perspective view from the discharge end of the preferred dryer illustrated in FIGS. 1-6.

FIG. 8 is a partial sectional side view of the preferred dryer illustrated in FIGS. 1-7.

FIG. 9 is a perspective view of the discharge end of the preferred dryer illustrated in FIGS. 1-8 with the exterior shell of the dryer removed.

FIG. 10 is a perspective view of the preferred dryer illustrated in FIGS. 1-9 with the exterior shell and the tertiary tubes removed.

FIG. 11 is a front view of the preferred dryer illustrated in FIGS. 1-10 with the exterior shell and the tertiary tubes removed.

FIG. 12 is a sectional view of the preferred dryer illustrated in FIGS. 1-11 taken along line A-A of FIG. 11.

FIG. 13 is a sectional view of the preferred dryer illustrated in FIG. 1-12 taken along line B-B of FIG. 11.

FIG. 14 is a schematic view of the preferred plant layout incorporating the dryer illustrated in FIGS. 1-13.

FIG. 15 is a plan view of an exemplary pellet plant including a first alternative embodiment of the dryer in accordance with the present invention.

FIG. 16 is an elevation view of the exemplary pellet plant including the first alternative embodiment of the dryer illustrated in FIG. 15.

FIG. 17 is a perspective view of the discharge end of the first alternative embodiment of the dryer illustrated in FIGS. 15-16.

### DESCRIPTION OF THE PREFERRED EMBODIMENTS OF THE INVENTION

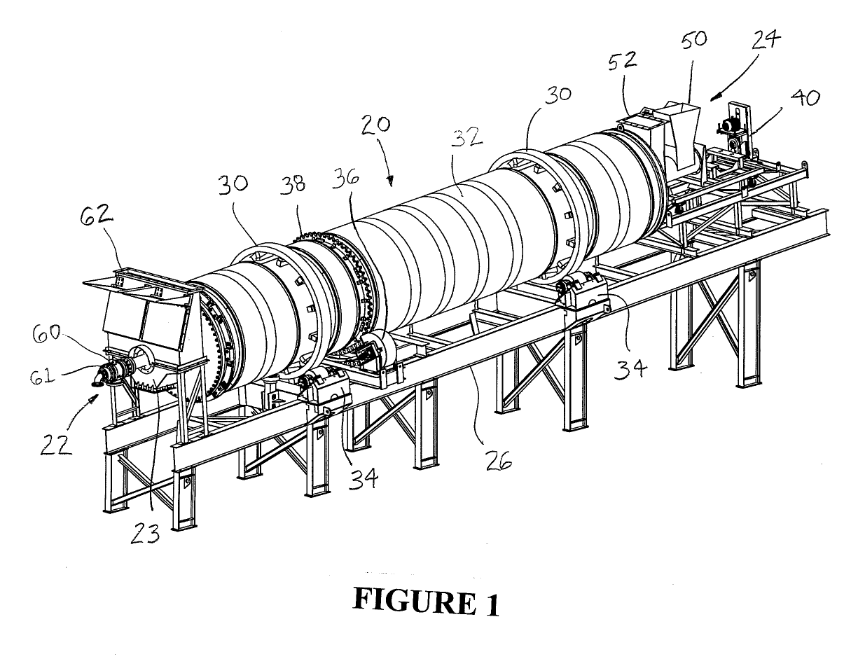

Referring now to the drawings, the preferred embodiments of the apparatus and method for a dryer are illustrated by FIGS. 1 through 17. As shown in the drawings, the preferred embodiments of the dryer are adapted to dry a variety of combustible and non-combustible materials including wood, sawdust, food, fly ash, aggregate, recycled asphalt and the like. The preferred embodiments of the dryer are also adapted to reduce undesirable emissions by eliminating the need for a burner assembly and reducing temperatures in the dryer. The preferred embodiments of the dryer are also adapted to reduce the risk of a fire and an explosion in the dryer by eliminating the need for a burner assembly and reducing the amount of oxygen in the atmosphere inside the dryer.

Referring now to FIG. 1, a perspective view from the discharge end of the preferred embodiment of the dryer in accordance with the present invention is illustrated. As shown in FIG. 1, the preferred dryer is designated generally by reference numeral 20. Preferred dryer 20 is a parallel flow rotary dryer, however, it is also contemplated within the scope of the invention that the dryer may be a counterflow rotary dryer. The rotational speed of preferred dryer 20 may be varied.

Still referring to FIG. 1, preferred dryer 20 includes discharge end 22 and inlet end 24. The preferred discharge end 22 is adapted to discharge the material dried by dryer 20 through discharge chute 23. The preferred inlet end 24 is adapted to receive the material dried by dryer 20 and heat transfer oil. Dryer 20 is preferably supported by frame 26 such that inlet end 24 is elevated above discharge end 22. Rings 30 are preferably disposed around exterior shell 32 of dryer 20 and are operatively connected to rotating mechanisms such as trunnions 34 which are mounted on frame 26. The preferred rings 30 and trunnions 34 are adapted to effect the rotational movement of dryer 20. In addition, saddle chain drive 36 operatively engages sprockets 38 to rotationally move preferred dryer 20 and screw drive 40. While the preferred dryer 20 is adapted to dry wood materials, it is also contemplated within the scope of the invention that the dryer may be used to thy other types of materials such as aggregate, sand and the like.

Referring still to FIG. 1, preferred dryer 20 includes material inlet chute and hopper 50. The preferred material inlet chute and hopper 50 is adapted to convey material to be dried by dryer 20 into the interior of the dryer. Preferred dryer 20 also includes steam vent 52 near discharge end 24. The preferred steam vent 52 is adapted to allow steam produced inside the dryer to be released from the dryer. At the discharge end 22 of preferred dryer 20, primary oil tube 60 is adapted to convey oil to and from the dryer. The preferred oil tube 60 is provided with a diversion device or mechanism such as rotary union valve 61 which is adapted to allow dryer 20 as a parallel flow dryer and a counterflow dryer. Also at discharge end 22, discharge housing 62 is adapted to discharge dried material though discharge chute 23. The preferred discharge housing 62 is also adapted to convey volatile organic compounds from the dryer. While FIG. 1 illustrates the preferred configuration and arrangement of the dryer, it is contemplated within the scope of the invention that the dryer may be of any suitable configuration and arrangement.

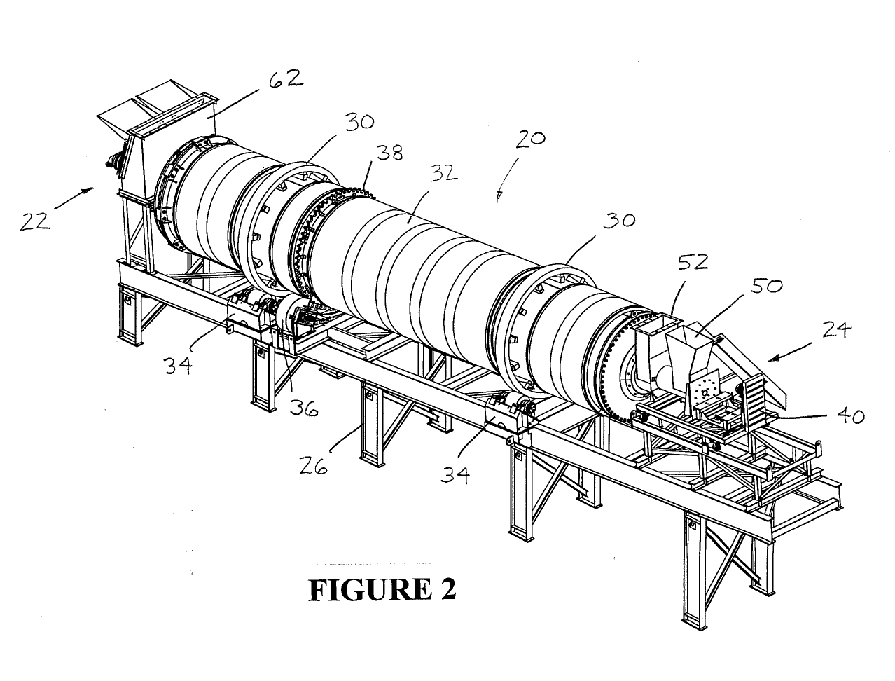

Referring now to FIG. 2, a perspective view from the inlet end of the preferred dryer is illustrated. As shown in FIG. 2, preferred dryer 20 includes discharge end 22, inlet end 24, frame 26, rings 30, exterior shell 32, trunnions 34, saddle chain drive 36, sprockets 38, screw drive 40, hopper 50, steam vent 52 and discharge housing 62.

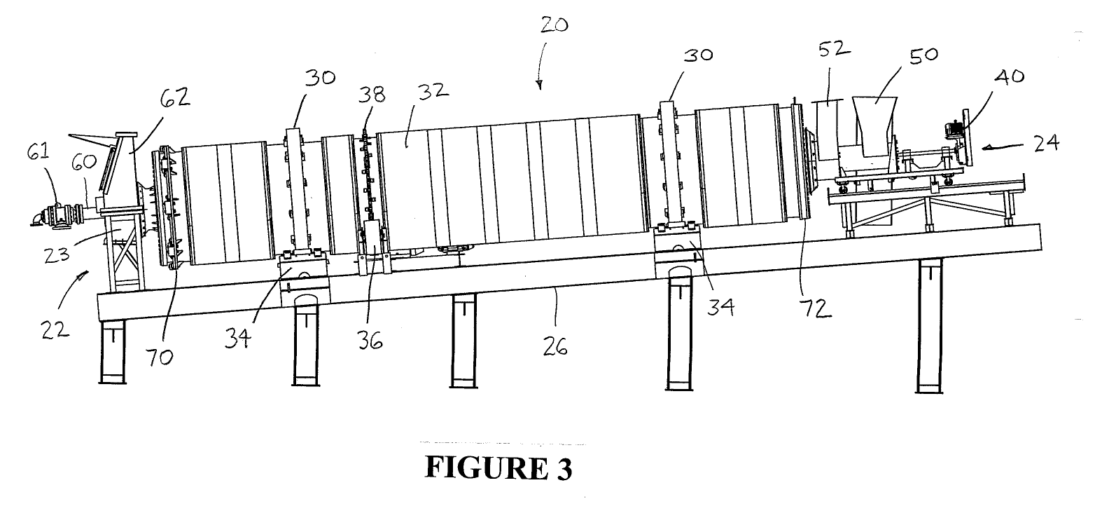

Referring now to FIG. 3, a front view of the preferred dryer is illustrated. As shown in FIG. 3, preferred dryer 20 includes discharge end 22, discharge chute 23, inlet end 24, frame 26, rings 30, exterior shell 32, trunnions 34, saddle chain drive 36, sprockets 38, screw drive 40, hopper 50, steam vent 52, primary tube 60, rotary union valve 61 and discharge housing 62. In addition, preferred dryer 20 includes discharge end manifold 70 and inlet end manifold 72. Preferred discharge end manifold 70 is a floating manifold which is adapted to accommodate the expansion and contraction of the oil tubes as they undergo temperature changes.

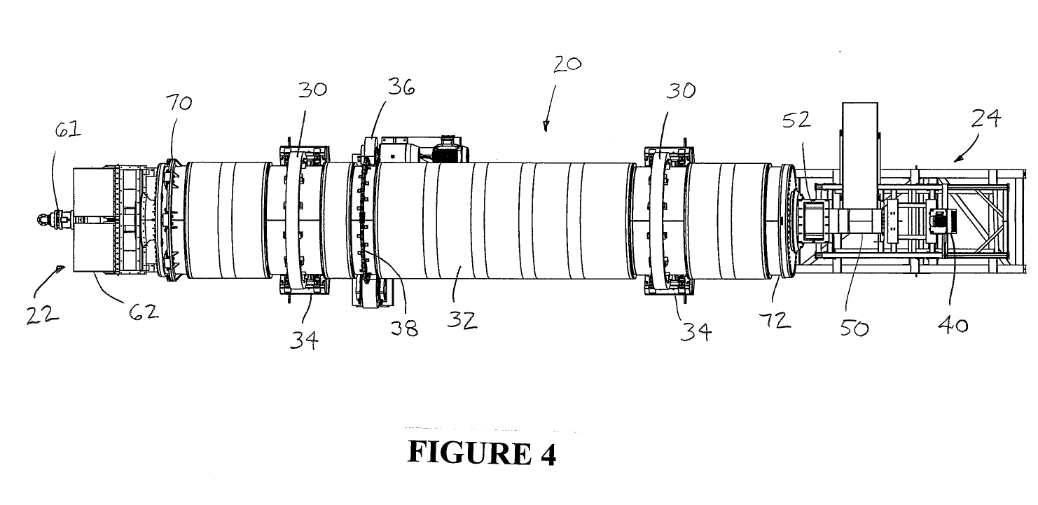

Referring now to FIG. 4, a top view of the preferred dryer is illustrated. As shown in FIG. 4, preferred dryer 20 includes discharge end 22, inlet end 24, frame 26, rings 30, exterior shell 32, trunnions 34, saddle chain drive 36, sprockets 38, screw drive 40, hopper 50, steam vent 52, rotary union valve 61, discharge housing 62, discharge end manifold 70 and inlet end manifold 72.

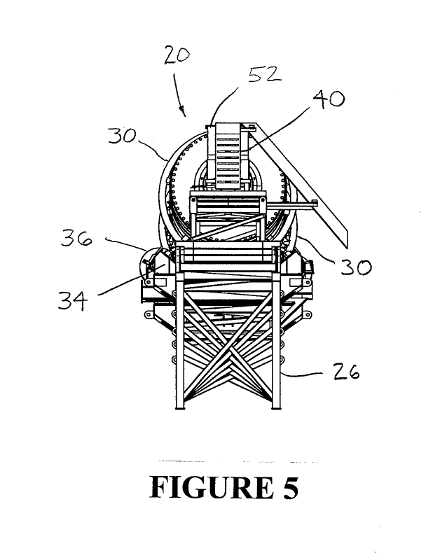

Referring now to FIG. 5, a right side view of the preferred dryer is illustrated. As shown in FIG. 5, preferred dryer 20 includes frame 26, rings 30, trunnions 34, saddle chain drive 36, screw drive 40 and steam vent 52.

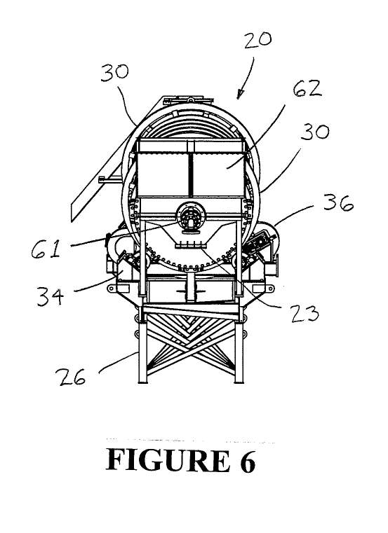

Referring now to FIG. 6, a left side view of the preferred dryer is illustrated. As shown in FIG. 6, preferred dryer 20 includes discharge chute 23, frame 26, rings 30, trunnions 34, saddle chain drive 36, rotary union valve 61 and discharge housing 62.

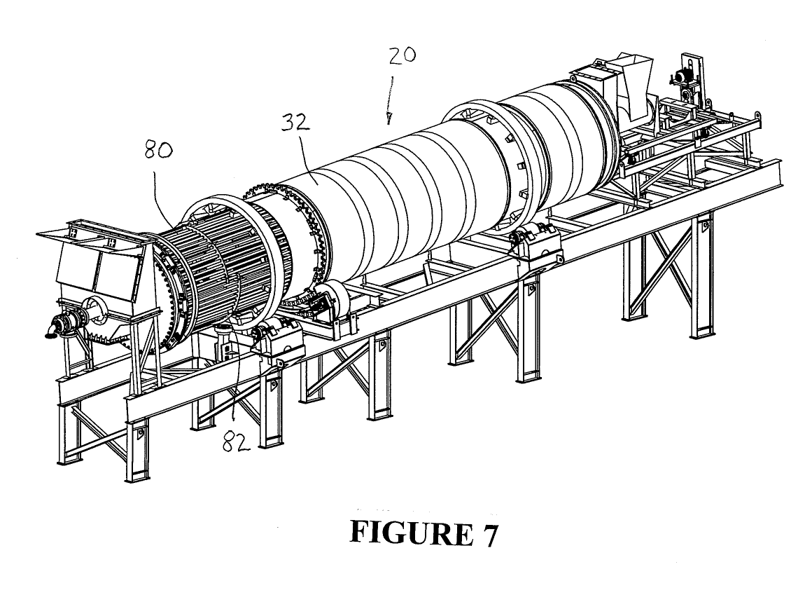

Referring now to FIG. 7, a partial sectional perspective view from the discharge end of the preferred dryer is illustrated. As shown in FIG. 7, preferred dryer 20 includes a plurality of tertiary tubes 80 within exterior shell 32. The preferred tertiary tubes 80 are adapted to convey heat transfer oil and are disposed substantially parallel to the longitudinal axis of dryer 20. The preferred tertiary tubes 80 are stacked on top of each other around the inside perimeter of exterior shell 32 and held in place by tube supports 82. Preferably, preferred tertiary tubes 80 are mounted to the inside perimeter of exterior shell 32 and adapted to rotate with the shell. The preferred tertiary tubes are approximately two inches in diameter, but it is contemplated within the scope of the invention that the diameter of the tertiary tubes may be larger or smaller than two inches. While FIG. 7 illustrates the preferred configuration and arrangement of the tertiary tubes, it is contemplated within the scope of the invention that the tertiary tubes may be of any suitable configuration and arrangement. The preferred temperature of the heat transfer oil conveyed in tertiary tubes 80 is between 300° F. and 550° F., however, it is contemplated within the scope of the invention that the temperature of the heat transfer oil conveyed in the tertiary tubes may be lower than 300° F. or higher than 550° F. Further, while the preferred oil pressure in the tertiary tubes is between 30 psi and 40 psi, it is contemplated within the scope of the invention that the oil pressure in the tertiary tubes may be higher or lower.

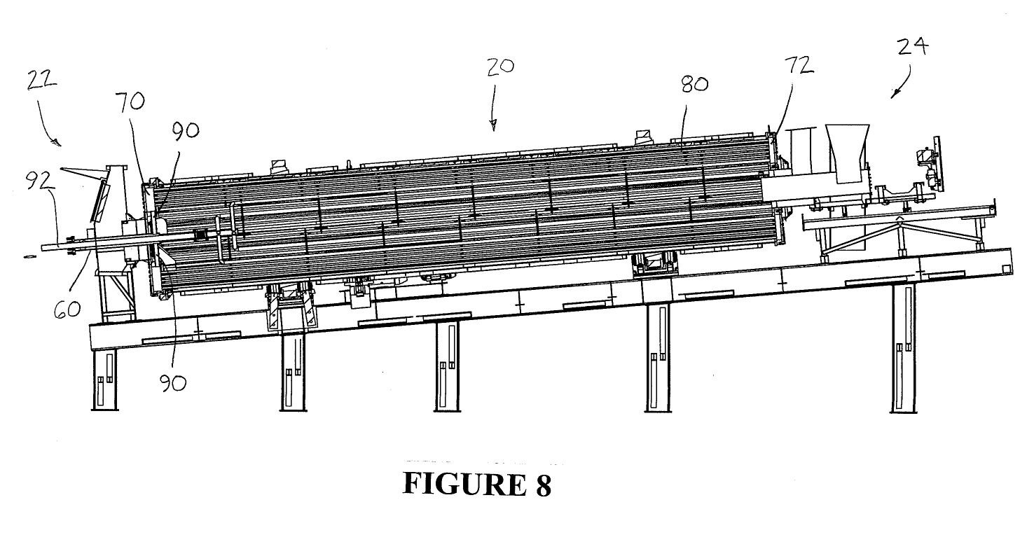

Referring now to FIG. 8, a partial sectional side view of the preferred dryer taken along the longitudinal axis is illustrated. As shown in FIG. 8, the preferred tertiary tubes 80 extend substantially the entire length of dryer 20. As also shown in FIG. 8, primary tube 60 and inlet end secondary tubes 92 are adapted to convey oil to and from dryer 20. In operation, when primary tube 60 is conveying heat transfer oil in to dryer 20, inlet end secondary tubes 92 are conveying heat transfer oil out from dryer 20. Similarly, when inlet end secondary tubes 92 are conveying heat transfer oil into dryer 20, primary tube 60 is conveying heat transfer oil out from dryer 20. More particularly, primary tube 60 is adapted to convey heat transfer oil to discharge end secondary tubes 90 which are in fluid communication with discharge end manifold 70 and tertiary tubes 80 to effect a counterflow dryer operation as heat transfer oil is conveyed in tertiary tubes 80 in a direction from discharge end 22 to inlet end 24. By contrast, inlet end secondary tubes 92 are adapted to convey heat transfer oil into dryer 20 to inlet end manifold 72 and tertiary tubes 80 to effect a parallel flow dryer operation as heat transfer oil is conveyed in tertiary tubes 80 in a direction from inlet end 24 to discharge end 22.

Still referring to FIG. 8, preferred discharge end manifold 70 is adapted to allow the secondary tubes and the plurality of tertiary tubes to expand and contract. The preferred tertiary tubes are welded to tube sheets on each end with one tube sheet being adapted to float or otherwise be displaced along the longitudinal axis of the dryer as the tertiary tubes expand and contract. The expansion and contraction of preferred secondary tubes is absorbed by a metallic bellows-type expansion joint because the oil temperatures are about 50 degrees different between the tertiary and secondary tubes. It has been observed that the preferred oil tubes expand and contract as much as two (2) inches per fifty (50) linear feet of tube between cold and operating temperatures. In the preferred embodiments of dryer 20, the secondary and tertiary tubes expand approximately the same amount, but it is contemplated within the scope of the invention that the secondary and tertiary tubes may expand and contract different distances. The preferred secondary tubes are approximately three inches in diameter, but it is contemplated within the scope of the invention that the diameter of the secondary tubes may be larger or smaller than three inches. Further, while FIG. 8 illustrates the preferred arrangement and configuration of the secondary tubes, it is contemplated within the scope of the invention that the secondary tubes may be of any suitable arrangement or configuration.

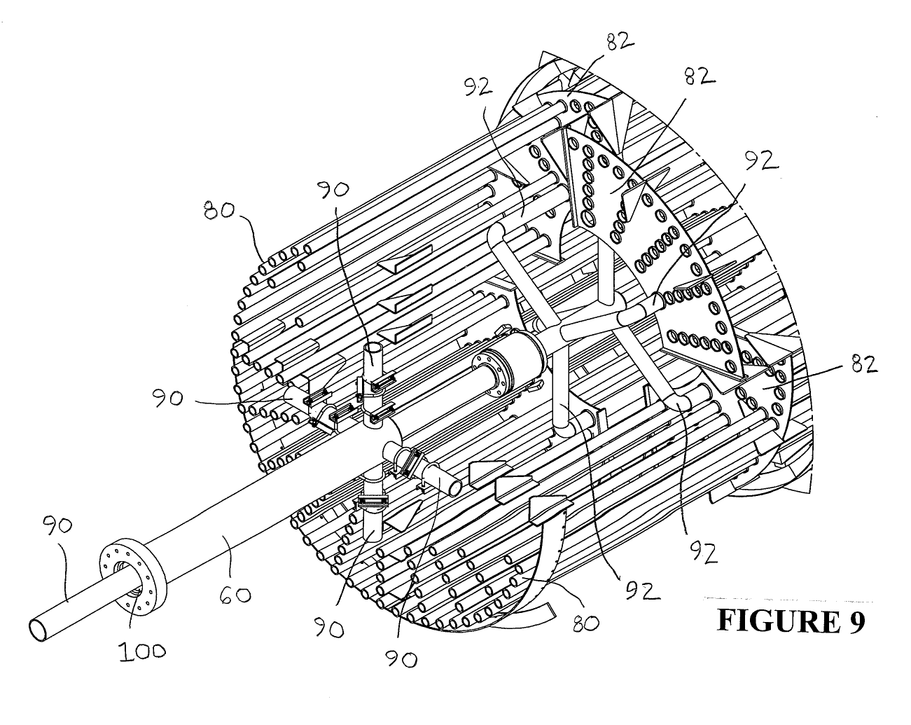

Referring now to FIG. 9, a perspective view of the discharge end of the preferred dryer is illustrated with the exterior shell of the dryer removed. As shown in FIG. 9, preferred primary tube 60 is disposed around a portion of inlet end secondary tubes 92 so as to form annulus 100. Annulus 100 is in fluid communication with discharge end secondary tubes 90. Preferred inlet end secondary tubes 92 and preferred tertiary tubes 80 are secured in dryer 20 with tube supports 82. While FIG. 9 illustrates the preferred configuration and arrangement of the tertiary tubes, it is contemplated within the scope of the invention that the oil tubes may be of any suitable configuration and arrangement. It is also contemplated within the scope of the invention that the tertiary tubes may be stacked fewer or more than five or six deep. Further, while the preferred primary tube 60 is approximately six inches, it is contemplated within the scope of the invention that the diameter of the primary tube may be larger or smaller than six inches.

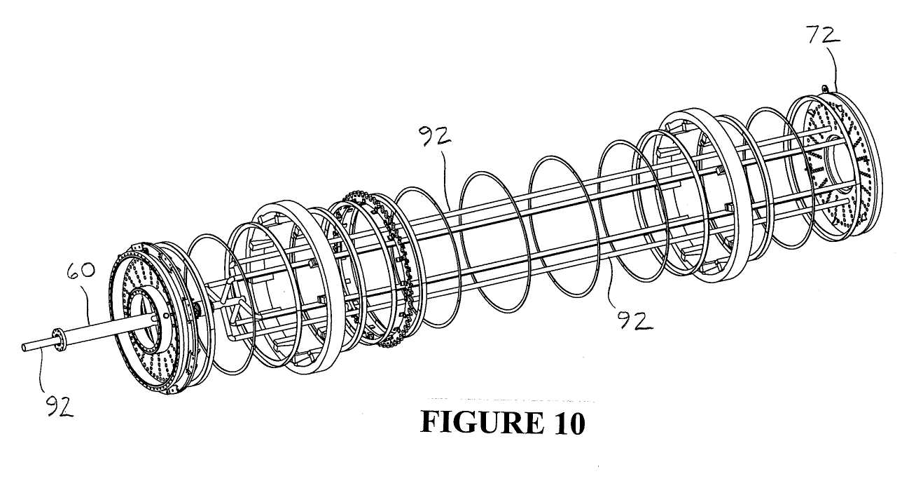

Referring now to FIG. 10, a perspective view of the preferred dryer is illustrated with the exterior shell and the tertiary tubes removed. As shown in FIG. 10, the preferred inlet end secondary tubes 92 extend along substantially the length of dryer 20 and are disposed substantially parallel to the longitudinal axis of the dryer. In addition, preferred inlet end secondary tubes 92 are in fluid communication with inlet end manifold 72.

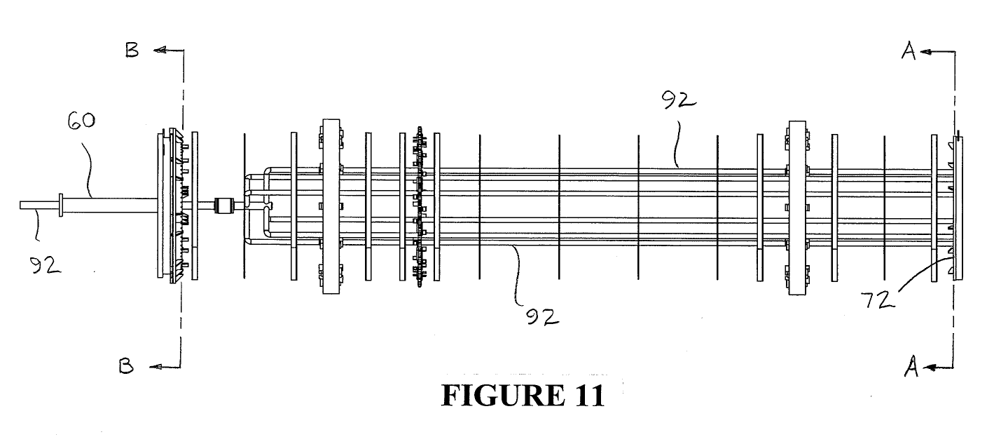

Referring now to FIG. 11, a front view of the preferred dryer is illustrated with the exterior shell and the tertiary tubes removed. As shown in FIG. 10, the preferred inlet end secondary tubes 92 extend along substantially the length of dryer 20, are disposed substantially parallel to the longitudinal axis of the dryer and are in fluid communication with inlet end manifold 72.

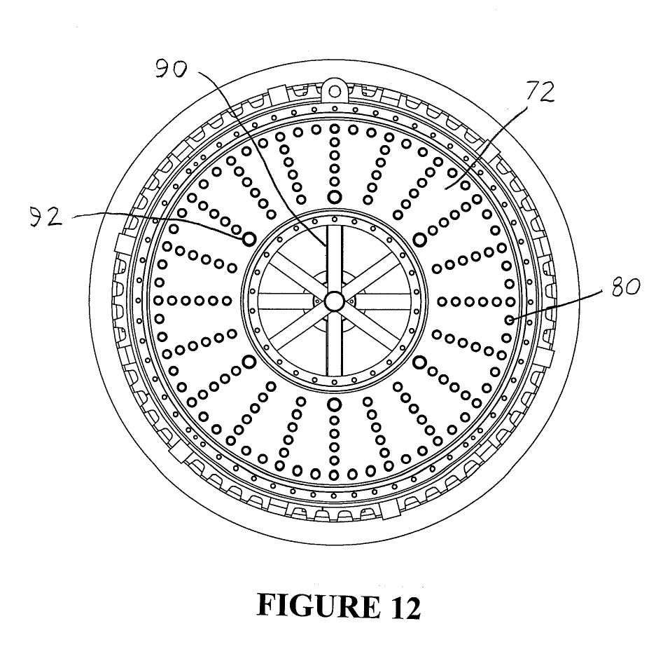

Referring now to FIG. 12, a sectional view of the preferred dryer taken along line A-A of FIG. 11 is illustrated. As shown in FIG. 12, tertiary tubes 80 and inlet end secondary tubes 92 are in fluid communication with inlet end manifold 72.

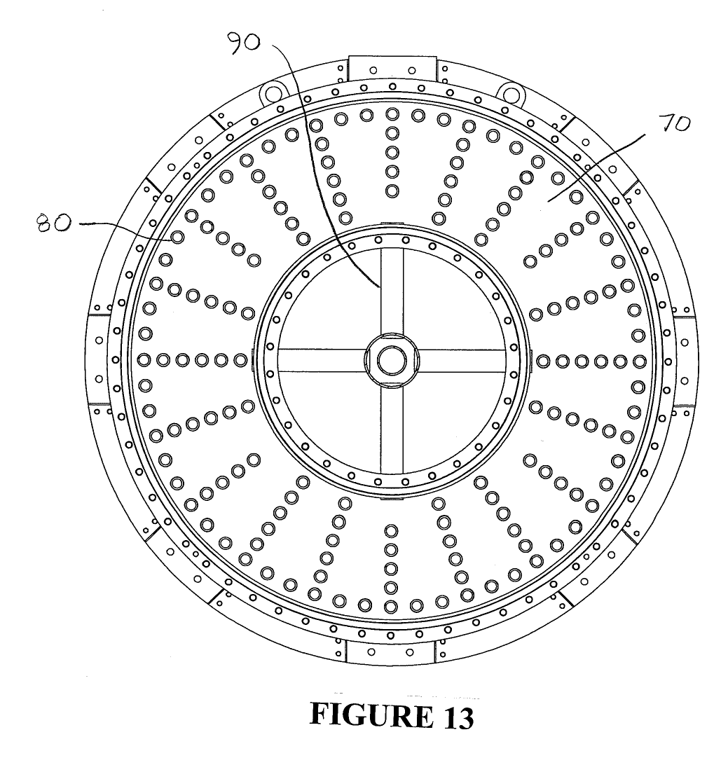

Referring now to FIG. 13, a sectional view of the preferred dryer taken along line B-B of FIG. 11 is illustrated. As shown in FIG. 13, discharge end secondary tubes 90 and tertiary tubes 80 are in fluid communication with discharge end manifold 70.

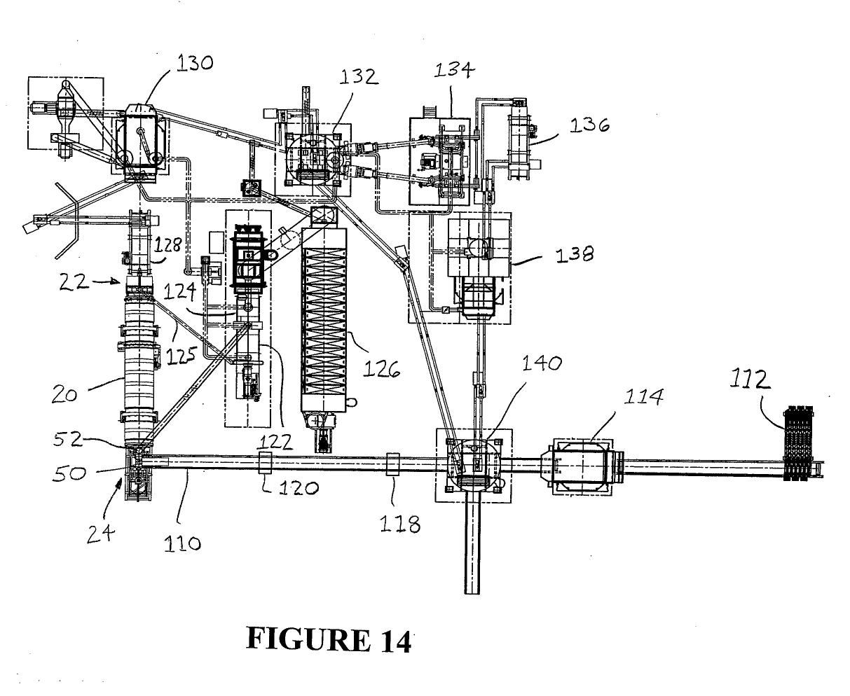

Referring now to FIG. 14, a schematic view of the preferred plant layout incorporating the dryer is illustrated. As shown in FIG. 14, the preferred dryer 20 is adapted to receive material from conveyor 110 which extends between bin 112 and hopper 50. Preferred conveyor 110 conveys material through first screen 114, past magnet 118 and past belt scale 120. Preferably, steam produced by dryer 20 is conveyed from inlet end 24 to the combustion chamber 122 of a heat source such as heater 124 by steam vent 52 and volatile organic compounds are conveyed from discharge end 22 to the combustion chamber of the heater by volatile organic compound vent 125. Conveying steam from dryer 20 to heater 124 reduces the production of nitrogen oxide and conveying volatile organic compounds from the dryer to the heater provides supplemental fuel to the heater. Emissions from heater 124 are preferably conveyed to baghouse 126.

Still referring to FIG. 14, after material is discharged by dryer 20, it may be conveyed to first rotary cooler 128 and second screen 130. Thereafter, the material may be conveyed to first surge bin 132, pellet press 134, second rotary cooler 136, third screen 138 and second surge bin 140. At a variety of locations in the preferred plant layout, including second screen 130, first surge bin 132, pellet press 134 and third screen 138, dust residue from the dried material may be conveyed to heater 124 as supplemental fuel. While FIG. 14 illustrates the preferred plant layout incorporating dryer 20, it is contemplated within the scope of the invention that any suitable plant layout may incorporate the preferred dryer.

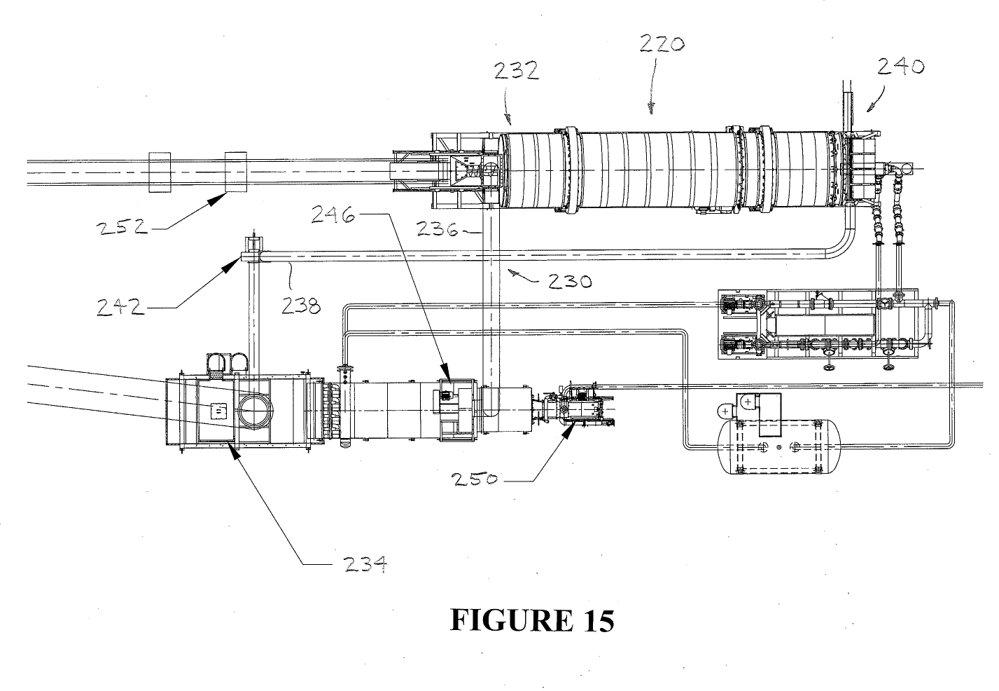

Referring now to FIG. 15, a plan view of an exemplary pellet plant including a first alternative embodiment of the dryer in accordance with the present invention is illustrated. As shown in FIG. 15, the preferred dryer is designated generally by reference numeral 220. Preferred dryer 220 comprises sweep gas assembly 230. Preferred sweep gas assembly 230 is adapted to convey gasified water and hydrocarbons from inlet end 232 of dryer 220 to a heat source such as thermal oil heater 234 via outlet duct 236. Then a small amount of spent exhaust gases is conveyed via inlet duct 238 from heater 234 to discharge end 240 of dryer 220 using a blower or any other suitable flow producing means such as recirculation fan 242. As the heated gas flows through dryer 220 it picks up gasified water and hydrocarbons which are conveyed through inlet end 232 and on to thermal oil heater 234 via outlet duct 236 using a blower or any other suitable flow producing means such as steam fan 246. Preferably, sweep gas assembly 230 increases the fuel efficiency of dryer 220 by using the gasified hydrocarbons as fuel. In addition, preferred sweep assembly 230 uses the gasified water to reduce flame temperature and thereby reduce nitrogen oxide emissions. Further, preferred sweep gas assembly 230 is adapted to dilute the atmosphere in dryer 220 and maintain it below the water vapor saturation point in order to prevent condensation from occurring when cold incoming feed enters the dryer and in colder areas of the dryer shell. Internal condensation has been found to reduce dryer throughput due to the re-circulating load of water. Still further, the heat transfer oil in preferred dryer 220 is approximately 550 degrees F. and it is frequently drying a material that is combustible below 550 degrees F. As a result, preferred sweep gas assembly 230 of dryer 220 produces an inert atmosphere of water vapor which is supplemented with a small gas stream of exhaust gases from heater 234 for the purpose of maintaining a gradient between the wet and dry bulb temperatures of the dryer atmosphere. The preferred exemplary pellet plant also comprises wood dust burner 250 and belt scale 252. While FIG. 15 illustrates the preferred configuration and arrangement of the sweep gas assembly, it is contemplated within the scope of the invention that the sweep gas assembly may be of any suitable configuration and arrangement.

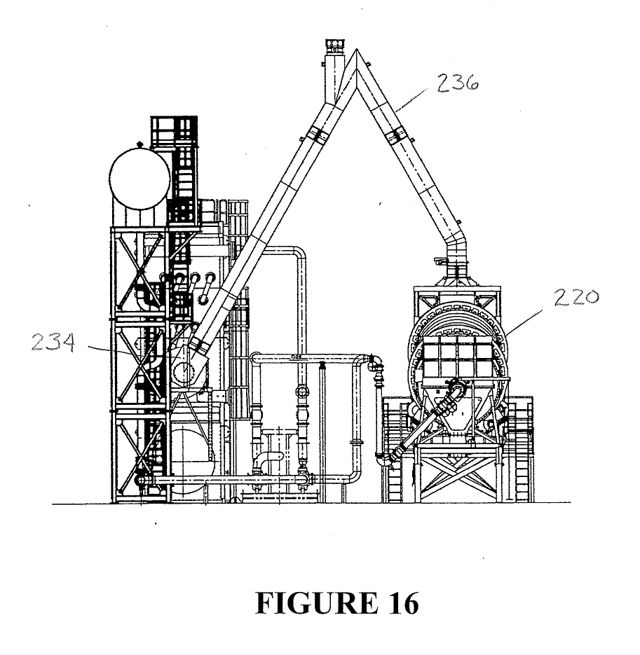

Referring now to FIG. 16, an elevation view of an exemplary pellet plant including preferred dryer 220 is illustrated. As shown in FIG. 16, preferred dryer 220 comprises thermal oil heater 234 and outlet duct 236.

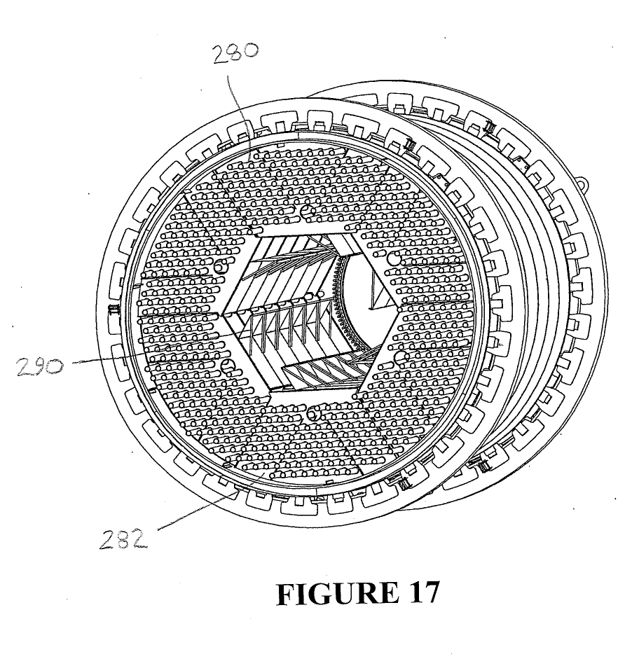

Referring now to FIG. 17, a perspective view of the discharge end of the first alternative embodiment of dryer 220 is illustrated with the exterior shell, the primary tube, and the secondary tubes of the dryer removed. As shown in FIG. 17, preferred tertiary tubes 280 are secured in dryer 220 with tube supports 282. In addition, preferred dryer 220 comprises baffles or lifters 290. Preferred lifters 290 are disposed on the interior of the dryer drum and allow the dryer drum to be filled with more material than would be possible without them. Preferred lifters 290 are adapted to cause the feed material to be dried in the dryer drum to be lifted above and across the rotating centerline and remain in contact with the hot oil tubes for a longer period of time in a given dryer length. While FIG. 17 illustrates the preferred configuration and arrangement of the lifters, it is contemplated within the scope of the invention that the lifters may be of any suitable configuration and arrangement.

The invention disclosed herein also comprises a method for drying wood materials in a dryer. The preferred methods in accordance with the present invention comprise the steps of providing a dryer such as the preferred dryers described and illustrated herein. The preferred methods also comprise the steps of introducing heat transfer oil into the dryer, introducing wood materials into the dryer and drying the wood materials. The preferred methods further comprise the steps of rotating the dryer, conveying steam from the dryer to the heat source, conveying volatile organic compounds from the dryer to the heat source.

In operation, several advantages of the preferred embodiments of the invention are achieved. For example, in the preferred embodiments of the invention, as heat transfer oil passes through the tubes, heat is transferred to the wood materials primarily by conduction through direct contact between the wood material and the tubes. Also in the preferred embodiments of the invention, the rotational movement of the dryer causes the material to move across and through the tubes and enhances the heat transfer. The preferred embodiments of the invention provide an apparatus and method that dries materials without the use of a burner assembly. The preferred embodiments of the invention also provide an apparatus and method that dries materials that are combustible. The preferred embodiments of the invention further provide an apparatus and method that minimizes the production of undesirable emissions when drying materials. Indeed, the exhaust from the preferred dryer consists almost entirely of steam with little or no volatile organic compounds. Further, the preferred embodiments of the invention are adapted to operate as a parallel flow and counterflow dryer.

In addition, the preferred embodiments of the invention provide an apparatus and method that reduces the temperature inside the dryer when drying materials. The preferred embodiments of the invention also provide an apparatus and method that reduces the risk of a fire and an explosion in the dryer when drying materials. The preferred embodiments of the invention further provide an apparatus and method that reduces the amount of oxygen inside the dryer when drying materials. In the preferred embodiments of the invention, the absence of any flame in the dryer and the relatively low temperature of the heat transfer oil together with the steam atmosphere produced by the drying material results in a very stable environment for drying combustible products with a greatly reduced risk of fire and explosion. Also in the preferred embodiments of the invention, because the atmosphere in the dryer is steam produced by the drying process, there is almost no oxygen present to support combustion. Further, the preferred embodiments of the invention provide an apparatus and method that is adapted to torrefy wood materials.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A dryer having an inlet end and a discharge end, said dryer comprising:
(a) an exterior shell;
(b) a discharge end manifold disposed near the discharge end of the dryer;
(c) an inlet end manifold disposed near the inlet end of the dryer;
(d) a primary tube, said primary tube being adapted to convey heat transfer oil to and from the dryer;
(e) a discharge end secondary tube, said discharge end secondary tube being in fluid communication with the primary tube and the discharge end manifold and being adapted to convey heat transfer oil;
(f) an inlet end secondary tube, said inlet end secondary tube being in fluid communication with the inlet end manifold and being adapted to convey heat transfer oil;
(g) a plurality of tertiary tubes, said plurality of tertiary tubes being in fluid communication with the discharge end manifold and the inlet end manifold and being adapted to convey heat transfer oil;
(h) a heat source adapted to heat the heat transfer oil;
(i) a sweep gas assembly adapted to convey gasified water and hydrocarbons from the inlet end of the dryer to the heat source;
wherein the heat transfer oil conveyed in the plurality of tertiary tubes flows in the same direction and the heat transfer oil conveyed in the plurality of tertiary tubes is adapted to conductively transfer heat to material in the dryer.

2. The dryer of claim 1 further comprising a rotating mechanism.

3. The dryer of claim 2 wherein the rotating mechanism comprises a sprocket and saddle chain drive.

4. The dryer of claim 2 wherein the rotating mechanism comprises a ring and a trunnion.

5. The dryer of claim 1 wherein the temperature of the heat transfer oil is between approximately 300° F. and approximately 550° F.

6. The dryer of claim 1 wherein the pressure of the heat transfer oil is between approximately 30 psi and 40 psi.

7. The dryer of claim 1 wherein the dryer is adapted to torrefy wood materials.

8. The dryer of claim 1 further comprising a rotary union valve.

9. The dryer of claim 1 wherein the dryer is adapted to perform parallel flow and counterflow operations.

10. The dryer of claim 1 wherein the discharge end manifold comprises a floating manifold adapted to allow the inlet end secondary tube, the discharge end secondary tube, and the plurality of tertiary tubes to expand and contract.

11. The dryer of claim 1 wherein the sweep gas assembly comprises a steam vent.

12. The dryer of claim 1 wherein the sweep gas assembly comprises a volatile organic compound vent.

13. The dryer of claim 1 wherein the primary tube and a portion of the inlet end secondary tube define an annulus therebetween.

14. The dryer of claim 14 wherein the discharge end secondary tube is in fluid communication with the annulus defined by the primary tube and the portion of the inlet end secondary tube.

15. The dryer of claim 1 further comprising at least one lifter.

16. A dryer having an inlet end and a discharge end and being adapted to dry wood materials, said dryer comprising:
(a) an exterior shell;
(b) a discharge end manifold disposed near the discharge end of the dryer, said discharge end manifold comprising a floating manifold;
(c) an inlet end manifold disposed near the inlet end of the dryer;
(d) a primary tube, said primary tube being adapted to convey heat transfer oil to and from the dryer;
(e) an inlet end secondary tube, said inlet end secondary tube being in fluid communication with the inlet end manifold and being adapted to convey heat transfer oil, and a portion of said inlet end secondary tube and said primary tube defining an annulus therebetween;
(f) a discharge end secondary tube, said discharge end secondary tube being in fluid communication with the annulus and the discharge end manifold and being adapted to convey heat transfer oil;
(g) a plurality of tertiary tubes, said plurality of tertiary tubes being in fluid communication with the discharge end manifold and the inlet end manifold and being adapted to convey heat transfer oil;
(h) a heat source adapted to heat the heat transfer oil;
(i) a sweep gas assembly adapted to convey gasified water and hydrocarbons from the inlet end of the dryer to the heat source;
wherein the heat transfer oil conveyed in the plurality of tertiary tubes flows in the same direction and the heat transfer oil conveyed in the plurality of tertiary tubes is adapted to conductively transfer heat to material in the dryer; and wherein the dryer is adapted to perform parallel flow and counterflow operations.

17. A method for drying wood materials, said method comprising:
(i) providing a dryer having an inlet end and a discharge end, said dryer comprising:
(1) an exterior shell;
(2) a discharge end manifold disposed near the discharge end of the dryer;
(3) an inlet end manifold disposed near the inlet end of the dryer;
(4) a primary tube, said primary tube being adapted to convey heat transfer oil to and from the dryer;
(5) a discharge end secondary tube, said discharge end secondary tube being in fluid communication with the primary tube and the discharge end manifold and being adapted to convey heat transfer oil;
(6) an inlet end secondary tube, said inlet end secondary tube being in fluid communication with the inlet end manifold and being adapted to convey heat transfer oil;
(7) a plurality of tertiary tubes, said plurality of tertiary tubes being in fluid communication with the discharge end manifold and the inlet end manifold and being adapted to convey heat transfer oil;
(8) a heat source adapted to heat the heat transfer oil;
(9) a sweep gas assembly adapted to convey gasified water and hydrocarbons from the inlet end of the dryer to the heat source;
wherein the heat transfer oil conveyed in the plurality of tertiary tubes flows in the same direction and the heat transfer oil conveyed in the plurality of tertiary tubes is adapted to conductively transfer heat to material in the dryer;
(j) introducing heat transfer oil into the dryer;
(k) introducing wood materials into the dryer;
(l) drying the wood materials.

18. The method of claim 17 further comprising rotating the dryer.

19. The method of claim 17 further comprising conveying steam from the dryer to the heat source.

20. The method of claim 17 further comprising conveying volatile organic compounds from the dryer to the heat source.
